(19) United States
(12) Patent Application Publication
(10) Pub. No.: US 2024/0222628 A1
(43) Pub. Date: Jul. 4, 2024

(54) ANODE INK FORMULATION FOR LITHIUM-ION BATTERY

(71) Applicant: Volt14 Solutions Pte. Ltd., Singapore (SG)

(72) Inventors: Puneet GUPTA, Singapore (SG); De Cheng FONG, Singapore (SG); Dzeneta HALILOVIC, Singapore (SG)

(21) Appl. No.: 18/557,627

(22) PCT Filed: Apr. 28, 2022
(86) PCT No.: PCT/SG2022/050264

§ 371 Date: Oct. 27, 2023

Related U.S. Application Data
(60) Provisional application No. 63/201,401, filed on Apr. 28, 2021.

(51) Int. Cl. H01M 4/583; H01M 4/02; H01M 4/04; H01M 4/38; H01M 4/62; H01M 10/0525

(52) U.S. Cl. CPC H01M 4/583; H01M 4/0404; H01M 4/386; H01M 4/621; H01M 4/625; H01M 10/0525; H01M 2004/027

(57) ABSTRACT

Provided herein is an anode ink formulation useful for manufacturing negative electrodes, and batteries comprising the same, and methods of preparation thereof.

### CROSS-REFERENCE TO RELATED APPLICATIONS

This application claims the benefit of priority of U.S. Provisional Application No. 63/201,401, filed on Apr. 28, 2021, the contents of which are hereby incorporated by reference in their entirety for all purposes.

### TECHNICAL FIELD

The present disclosure generally relates to the field of energy storage. More particularly, the present disclosure relates to an anode ink formulation for batteries, electrodes and energy storage devices comprising the same and methods of preparation thereof.

### BACKGROUND

Lithium-ion batteries (LIBs) have been widely used as power supplies for portable electronic devices due to their higher gravimetric and volumetric energy densities compared to other electrochemical energy storage technologies such as lead-acid, Ni—Cd and Ni-MH batteries. As the usage of portable electronic devices (such as mobile phones, laptop computers etc.) has significantly increased over the past decades, power supplies with higher volumetric as well as gravimetric energy density are needed to satisfy growing performance requirements. Among the commercialized electrochemical energy storage technologies, LIBs provide the highest energy density. Conventional rechargeable LIBs are composed of cathode and anode electrodes along with Li-ion conducting electrolyte and a separator. During charging the cathode material is oxidized. Li-ions are extracted, and they move towards the anode. The reactions are reversed during discharging and the Li-ion move from the anode to the cathode through the electrolyte.

Commonly used cathode materials include lithium cobalt oxide (LCO), lithium nickel manganese cobalt oxide (NMC), lithium iron phosphate (LFP), etc. The theoretical capacity of metal-based cathode materials is no more than 300 mAh/g, whereas sulfur exhibits ˜1,675 mAh/g though it is still at the research stage. Existing LIBs with graphite-based anodes, and lithium metal-oxide or lithium phosphate-based cathodes, are reaching their theoretical limits for energy and power densities. Hence, the development of higher capacity anode materials offers a great opportunity for the successful implementation of advanced LIBs.

Based on different lithiation/delithiation mechanisms, three classes of anode materials can be differentiated for rechargeable LIBs, i.e., intercalation, alloying, and conversion materials. Graphite is the most used anode material in today's commercialized LIBs. Being an intercalation material, graphite allows insertion and removal of lithium between the graphene sheets. Graphite has a theoretical capacity of 372 mAh/g, which corresponds to the composition of LiC₆ in a fully lithiated state. The other class of anode materials, known as conversion materials, are still at the research stage. A conversion material is usually a transition metal coupled with an anion, such as Fe₂O₃, Co₃O₄, etc. Various alloying materials, such as pure Si, Sn. Al, Mg, and their alloys, have been extensively studied as potential candidates for the next generation anode materials in LIBs due to their higher capacity compared to graphite. Among all these materials, silicon-based materials are considered as the most promising candidates due to their outstanding energy density. A fully lithiated phase observed in the studies was Li₂₂Si₅, which corresponds to a theoretical capacity of ˜ 4,200 mAh/g at 400° C., whereas it is ˜3,579 mAh/g at RT with Li₁₅Si₄ phase.

However, silicon's practical applications have been hindered mainly by the large volume change during cell operation that leads to electrical conduction loss and a drastic capacity reduction.

The large volume change of silicon particles during cycling can result in breaking-down of the electrical contact between silicon particles, current collector as well as the conducting additive. Besides, the solid electrolyte interphase (SEI) layer formed on the silicon electrode is unstable and cannot sufficiently prevent continuous electrolyte decomposition. Both issues highlight the importance of the binder on the electrochemical performance of silicon electrodes. Indeed, the conventionally used polyvinylidene fluoride (PVDF) binders have proven to be not suitable for silicon-based materials due to poor adhesion and cyclability.

Various kinds of binders, especially water-based binders, have been widely explored in recent years. CMC, poly(acrylic acid) (PAA), chitosan, and alginate are so far the most promising candidates. They have the added advantage of being prepared from natural materials and are soluble in water or slightly ionic solvents. Thus, they have reduced or no toxicity and therefore can be regarded as green materials, which are important in terms of producing sustainable materials for LIBs.

Nonetheless, there still exists a need for improved anode ink formulations that address or overcome at least some of the shortcomings described above.

### SUMMARY

The present disclosure provides an anode ink formulation, electrodes and energy storage devices prepared using the same and methods of preparation thereof. The anode ink formulation described herein can exhibit strong adhesive bonding to the current collector, superior cohesive-properties, and excellent electrochemical stability. Also provided is a simple scalable method of manufacturing the anode ink formulation described herein. The anode ink formulation can better accommodate the large volume changes of silicon anodes resulting from lithium insertion and extraction. The anode ink formulation exhibits superior capacity, good cycling performance and excellent coulombic efficiency.

In a first aspect, provided herein is an anode ink formulation comprising a binder composition, at least one active material, and at least one conductive material, wherein the binder composition comprises chitosan, at least one phosphate salt or conjugate acid thereof, and water, wherein the at least one phosphate salt is selected from the group consisting of orthophosphate metal salts, pyrophosphate metal salts, and polyphosphate metal salts; the binder composition, the at least one active material, and the at least one conductive material are present at a concentration of 10% to 30% wt/wt; 50 to 80% wt/wt; and 10 to 20% wt/wt, respectively; and the binder composition comprises the chitosan and the at least one phosphate salt or conjugate acid thereof at a concentration between 1.5-5% wt/wt.

In certain embodiments, the at least one active material is selected from the group consisting of silicon, SiOₓ, graphite, tin, antimony, gallium, hard carbon, and combinations thereof, wherein x is 0<x<2.

In certain embodiments, the at least one active material is silicon and graphite or graphite.

In certain embodiments, the at least one conductive material is selected from the group consisting of carbon black. Ketjen black, single-walled carbon nanotube (SWCNT), multi-walled carbon nanotube (MWCNT), carbon nanofibers (CNF), graphene, hard carbon, graphene oxide, conductive polymers, and combinations thereof.

In certain embodiments, the at least one conductive material is carbon black, CNF, or a mixture thereof.

In certain embodiments, the binder composition comprises the chitosan and the at least one phosphate salt or conjugate acid thereof at a concentration of 1.5-2.5% wt/wt.

In certain embodiments, the binder composition further comprises an organic or inorganic acid at a concentration of 0.5% to 3% v/v.

In certain embodiments, the binder composition comprises chitosan and sodium tripolyphosphate in a mass ratio 5:1 to 20:1 mass ratio.

In certain embodiments, the at least one active material has a D50 particle size distribution between 50-300 nm.

In certain embodiments, the binder composition, the at least one active material, and the at least one conductive material are present at a concentration of 15% to 25% wt/wt; 60 to 70% wt/wt; and 12 to 17% wt/wt, respectively.

In certain embodiments, the method for preparing the anode ink formulation comprises at least one addition method selected from the group consisting of combining the active material portion-wise with the binder composition; combining the conductive material portion-wise with the binder composition; combining the conductive material with the binder composition before the active material is combined with the binder composition; and premixing the at least one active material and the at least one conductive material thereby forming a premixture and combining the premixture with the binder composition.

In certain embodiments, the method for preparing the anode ink formulation comprises combining the conductive material with the binder composition before the active material is combined with the binder composition; or premixing the at least one active material and the at least one conductive material thereby forming a premixture and combining the premixture with the binder composition.

In certain embodiments, the anode ink formulation comprises:
a binder composition, at least one active material, and at least one conductive agent,
wherein the binder composition comprises chitosan, at least one phosphate salt or conjugate acid thereof, and water, wherein the at least one phosphate salt is selected from the group consisting of orthophosphate metal salts, pyrophosphate metal salts, and polyphosphate metal salts;
the at least one active material is selected from the group consisting of silicon, SiOₓ, graphite, tin, antimony, gallium, and combinations thereof, wherein x is 0<x<2;
the at least one conductive material is selected from the group consisting of carbon black, Ketjen black, single-walled carbon nanotube (SWCNT), multi-walled carbon nanotube (MWCNT), carbon nanofibers (CNF), graphene oxide, conductive polymers, and combinations thereof;
the binder composition, the at least one active material, and the at least one conductive material are present in at a concentration of 10% to 30% wt/wt; 50 to 80% wt/wt; and 10 to 20% wt/wt, respectively; and
the binder composition comprises the chitosan and the at least one phosphate salt or conjugate acid thereof at a concentration between 1.5-2.5% wt/wt.

In certain embodiments, the anode ink formulation comprises:
a binder composition, at least one active material, and at least one conductive agent,
wherein the binder composition comprises chitosan, at least one phosphate salt or conjugate acid thereof, and water, wherein the at least one phosphate salt is selected from the group consisting of orthophosphate metal salts, pyrophosphate metal salts, and polyphosphate metal salts;
the at least one active material is silicon and graphite or graphite;
the at least one conductive material is carbon black, CNF, or a mixture thereof;
the binder composition, the at least one active material, and the at least one conductive material are present in at a concentration of 15% to 25% wt/wt; 60 to 70% wt/wt; and 12 to 17% wt/wt, respectively; and
the binder composition comprises the chitosan and the at least one phosphate salt or conjugate acid thereof at a concentration between 1.75-2.25% wt/wt.

In certain embodiments, the least one active material has a D50 particle size distribution between 50-200 nm.

In certain embodiments, the method for preparing the anode ink formulation comprises adding the conductive material before the active material; or adding the active material in at least two portions before adding the conductive material in at least two portions.

In a second aspect, provided herein is a method of preparing the anode ink formulation of the first aspect, the method comprising:
combining an aqueous solution comprising an acid, chitosan, and the least one phosphate salt or conjugate acid thereof thereby forming the binder composition; and
combining the binder composition, the at least one active material, the at least one conductive material, and thereby forming the anode ink formulation.

In certain embodiments, the step of combining the at least one active material, the at least one conductive material, and the binder comprises:
combining the binder composition and the at least one conductive material thereby forming a binder composition comprising the conductive material; and
combining the at least one active material and the binder composition comprising the conductive material thereby forming the anode ink formulation; or
combining the at least one active material and the at least one conductive material thereby forming a premixture; and combining the premixture with the binder composition thereby forming the anode ink formulation.

In a third aspect, provided herein is a method of preparing a negative anode, the method comprising removing at least a some of the water from the anode ink formulation of the first aspect.

In certain embodiments, the method further comprises the step of applying the anode ink formulation to the surface of a current collector and removing at least a portion of the water from the anode ink formulation thereby forming a coated current collector.

In a fourth aspect, provided herein is a negative anode prepared according to the third aspect.

In a fifth aspect, provided herein is a battery comprising a positive electrode; the negative electrode of the fourth aspect disposed opposite to the positive electrode; and an electrolyte disposed between the positive electrode and the negative electrode.

### BRIEF DESCRIPTION OF DRAWINGS

The above and other objects and features of the present disclosure will become apparent from the following description of the disclosure, when taken in conjunction with the accompanying drawings.

FIG. 1 depicts an exemplary schematic diagram for preparing the anode ink formulation in accordance with certain embodiments described herein.

FIG. 2 depicts Fourier transform infrared (FTIR) spectra of polymer and cross-linked polymer.

FIG. 3 depicts G′, G″ vs shear stress for cross-linked polymer in accordance with certain embodiments described herein

FIG. 4A depicts the repeatability of the performance in accordance with certain embodiments described herein.

FIG. 4B depicts the effect of different mass loading in accordance with certain embodiments described herein on capacity.

FIG. 4C depicts the effect of different conductive materials in accordance with certain embodiments described herein.

FIG. 4D depicts the effect of order of addition/sequence of active material and conductive material in accordance with certain embodiments described herein.

FIG. 4E depicts the effect of order of addition/sequence of active material and conductive material in accordance with certain embodiments described herein.

FIG. 4F depicts the effect of active material particle size in accordance with certain embodiments described herein.

FIG. 5A shows an exemplary battery configuration according to certain embodiments described herein.

FIG. 5B shows an exemplary battery configuration according to certain embodiments described herein.

FIG. 5C depicts an exemplary battery configuration according to certain embodiments described herein.

### DETAILED DESCRIPTION

### Definitions

The definitions of terms used herein are meant to incorporate the present state-of-the-art definitions recognized for each term in the field of biotechnology. Where appropriate, exemplification is provided. The definitions apply to the terms as they are used throughout this specification, unless otherwise limited in specific instances, either individually or as part of a larger group.

When trade names are used herein, applicants intend to independently include the trade name product ingredient(s) of the trade name product.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

The present disclosure relates to a water-based coatable anode ink formulation for lithium-ion battery application comprising at least one active material, at least one conductive material, a water-soluble polymeric binder, and optional modifiers. Also provided herein are formulation methods and methods of preparing batteries comprising the same. The anode ink formulation described herein features strong adhesive bonding of the electrode material to the current collector, superior cohesive properties, and excellent electrochemical stability as a result of its superior electronic and ionic conductivities.

Anode ink formulations comprising chitosan in combination with additional materials to be the platform for anode ink formulations. This is due to the versatility, biodegradability of this polymer along with a high positive charge density. Chitosan is mainly produced by the alkaline de-N-acetylation of chitin, the second most abundant polysaccharide in nature after cellulose. Chitin is primarily sourced from crustacean and insect shells. It has a randomly distributed β-1-4 linked D-glucosamine (GlcN) and N-acetyl-D-glucosamine (GlcNAc) structure. Two important structural parameters that influence chitosan's solubility and many of its physicochemical properties, like protonation, are the degree of deacetylation and the molecular weight. A cross-link is a bond/bridge that links one polymer chain to one or more other polymeric chains to form interconnected 3D type networks. The cross-link can be either covalently or ionically bonded. Aldehydes can be used to react with amino groups on the chitosan to form covalent bonds. Ionic cross-linking can form between a positively or negatively charged polymer and an oppositely charged cross-linking agent leading to the formation of a network through ionic bridges between the polymeric chains.

Properties of chitosan are influenced by several parameters, such as its molecular weight (10,000-1,000,000 Da) and degree of deacetylation (representing the ratio of 2-amino-2-deoxy-d-glucopyranose to 2-acetamido-2-deoxyd-glucopyranose structural units in the chitosan). The degree of deacetylation of the chitosan used in the binders described herein can range from 0% to 100%. In certain embodiments, the degree of deacetylation of the chitosan used in the binders described herein is greater than 1%, greater than 5%, greater than 10%, greater than 20%, greater than 30%, greater than 40%, greater than 50%, greater than 60%, greater than 70%, greater than 80%, greater than 90%, greater than 95%, greater than 97%, greater than 98%, greater than 99%, or greater than 99.9%. In certain embodiments, the degree of deacetylation of the chitosan used in the binders described herein is between 50-100%, 60-99%, 65-99%, 65-99%, 65-99%, 70-99%, 75-99%, or 75-95%. In certain embodiments, the degree of deacetylation of the chitosan used in the binders described herein is between 75-95%.

The chitosan can have a molecular weight of 10,000-1,000,000 Da. In certain embodiments, the chitosan can have a molecular weight of 10,000-500,000; 20,000-500,000; 30,000-500,000; 40,000-500,000; 40,000-450,000; or 40,000-400,000 Da. In certain embodiments, the chitosan can be low molecular weight (molecular weight 50,000-190,000 Da), medium molecular weight chitosan (molecular weight 190,000-310,000 Da); or high molecular weight chitosan (molecular weight ˜310,000->375,000 Da).

Chitosan, a cationic copolymer of glucosamine and N-acetylglucosamine, is a partially deacetylated derivative of a natural polysaccharide—chitin, which is one of the most abundant carbohydrates in nature and is mostly derived from the exoskeleton of crustaceans. Chitosan has a unique set of useful characteristics, such as bio-renewability, biodegradability, biocompatibility, bio-adhesivity and nontoxicity. Chitosan and its derivatives are used in various fields such as pharmaceutical, biomedicine, water treatment, cosmetics, agriculture, and food industry.

Chitosan can exist as a polycationic polymer, which is well known for its chelating properties. Therefore, interactions with negatively charged components, such as phosphate metal salts, can lead to the formation of a network ionically phosphate crosslinked chitosan chains. Ionic interactions between the negative charges of the phosphate and positively charged groups of chitosan are thought to be the major molecular interactions inside the crosslinked network. The formation of the network ionically phosphate crosslinked chitosan chains can be prepared by combining cationic chitosan and at least one phosphate salt; or in the alternative by combining neutral chitosan with the conjugate acid of at least one phosphate salt. Consequently, the binder compositions contemplated herein encompass binder compositions comprising chitosan and at least one phosphate salt or a conjugate acid thereof.

The binder provided herein can comprise chitosan and at least one phosphate salt selected from the group consisting of orthophosphate metal salts, pyrophosphate metal salts, and polyphosphate metal salts. In certain embodiments, the binder has 1, 2, 3, 4, or more different types of phosphate salts.

Polyphosphate metal salts suitable for use in the binder described herein include, but are not limited to, linear polyphosphate metal salts, metaphosphate metal salts, and branched polyphosphate metal salts. Exemplary polyphosphate metal salts include, but are not limited to, triphosphate salts, tetraphosphate salts, pentaphosphate salts, trimetaphosphate salts, tetrametaphosphate salts, and the like.

The at least one phosphate salt can comprise any metal cation. Exemplary metal cations include one or more cations selected from Group 1 and Group II of the Periodic Table of the Elements. In certain embodiments, the at least one phosphate salt can comprise one or more metal cations selected from the group consisting of Li⁺, Na⁺, K⁺, Mg²⁺, and Ca²⁺. In certain embodiments, the at least one phosphate salt is a sodium orthophosphate, sodium pyrophosphate, or a sodium polyphosphate. In certain embodiments, the at least one phosphate salt is sodium tripolyphosphate. The binder can also comprise chitosan and at least one phosphate salt conjugate acid selected from the group consisting of conjugate acids of orthophosphate, pyrophosphate, and polyphosphate.

Conjugate acids of orthophosphate, pyrophosphate, and polyphosphate suitable for use in the binder described herein include, but are not limited to, linear polyphosphoric acids, metaphosphoric acids, and branched polyphosphoric acids. Exemplary polyphosphoric acids include, but are not limited to, triphosphoric acids, tetraphosphoric acids, pentaphosphoric acids, trimetaphosphoric acid, tetrametaphosphoric acids, and the like. In certain embodiments, the conjugate acid of the phosphate salt is polyphosphoric acid (CAS Number: 8017-16-1).

The conjugate acids of orthophosphate, pyrophosphate, and polyphosphate can comprise one or more ionizable protons and thus can exist in one or more conjugate acid protonation states. In instances in which the binder composition comprises a conjugate acid of orthophosphate, pyrophosphate, or polyphosphate, the conjugate acid can be in any of the possible protonation states of the phosphate salts described herein or a combination thereof. For example, conjugate acids of PO₄³⁻ (orthophosphate) include HPO₄²⁻, H₂PO₄⁻, and H₃PO₄; and conjugate acids of P₃O₁₀⁵⁻ (tripolyphosphate) include HP₃O₁₀⁴⁺, H₂P₃O₁₀³⁻, H₃P₃O₁₀²⁻, H₄P₃O₁₀¹⁻, and H₅P₃O₁₀. Anionic conjugate acids of the phosphate salts can comprise any one or more of the metal cations described herein.

The binder may comprise the at least one phosphate salt or a conjugate acid thereof and chitosan in a 1:1 to 1:10,000 mass ratio. In certain embodiments, the binder comprises the at least one phosphate salt and chitosan in a 1:1 to 1:10,000; 1:1 to 1:5,000; 1:1 to 1:1,000; 1:1 to 1:500; 1:1 to 1:250; 1:1 to 1:100; 1:1 to 1:20; 1:1 to 1:10; 1:5 to 1:10; 1:6 to 1:10; 1:7 to 1:10; 1:7 to 1:9; or 1:8 to 1:9 mass ratio. In certain embodiments, the binder comprises less than 1 part by weight of the at least one phosphate salt to 4 parts by mass of chitosan. In certain embodiments, the binder comprises the at least one phosphate salt in a mass ratio of less than 1 part by mass of the at least one phosphate salt to 5 parts by mass of chitosan; less than 1 part by mass of the at least one phosphate salt to 6 parts by mass of chitosan; less than 1 part by mass of the at least one phosphate salt to 7 parts by mass of chitosan; less than 1 part by mass of the at least one phosphate salt to 8 parts by mass of chitosan; or less than 1 part by mass of the at least one phosphate salt to 9 parts by mass of chitosan. In the examples below, the binder comprises sodium tripolyphosphate and chitosan in about a 1:8.3 mass ratio.

Chitosan is relatively insoluble in water and in most organic and alkali solvents. However, chitosan is soluble in solvents comprising dilute organic acids, such as acetic acid, formic acid, lactic acid, oxalic acid, benzoic acid, and lactic acid. Provided herein is a binder composition comprising the binder described herein and a solvent optionally comprising an organic acid. The solvent may be an aqueous solvent, a polar organic solvent, or a mixture thereof. Suitable polar organic solvents include, but are not limited to, alcohols, alkyl halides, dialkylformamides, dialkyl ketones, dialkyl sulfoxides, tertiary amides, and combinations thereof. Exemplary polar organic solvents include, but are not limited to, methanol, ethanol, isopropanol, dimethylformamide (DMF), dimethylsulfoxide (DMSO), dimethylacetamide (DMA), acetone, methyl ethyl ketone, and N-methyl-2-pyrrolidone. The organic acid may be acetic acid, propionic acid, formic acid, lactic acid, oxalic acid, succinic acid, tartaric acid, malic acid, benzoic acid, methylsulfonic acid, phenylsulfonic acid, toluenesulfonic acid, or a combination thereof. The organic acid may be present in the solvent at a concentration of about 0.1-5% v/v. 0.1-4% v/v. 0.1-3% v/v. 0.5-3% v/v, 0.5-2.5% v/v, 1.0-2.5% v/v, 1.0-2.5% v/v, 1.5-2.5% v/v. 0.5-1.5% v/v, about 1% v/v, or about 2% v/v. In certain embodiments, the organic acid is acetic acid. In instances in which a conjugate acid of the phosphate salt is used, it can be used in place of the organic acid to solubilize chitosan in a solvent, such as water.

The binder composition may comprise the chitosan and the at least one phosphate salt at a concentration of 0.1% wt/wt or greater, wherein the concentration is determined according to the formula: (weight of the at least one phosphate salt+weight of chitosan)/(weight of solvent+weight of the at least one phosphate salt+weight of chitosan). In certain embodiments, the binder has a solids content of 0.5% wt/wt, 1.0% wt/wt, 1.5% wt/wt. 2.0% wt/wt or greater. In certain embodiments, the binder composition comprises the chitosan and at the least one phosphate salt at a concentration between 0.1-20% wt/wt. 1.5-20% wt/wt, 0.1-15% wt/wt, 1.5-15% wt/wt, 1.5-10% wt/wt, 1.5-9% wt/wt, 1.5-8% wt/wt, 1.5-7% wt/wt, 1.5-6% wt/wt, 1.5-5% wt/wt, 1.5-4% wt/wt, 1.5-3% wt/wt, 1.5-2.5% wt/wt, 1.6-2.4% wt/wt, 1.7-2.3% wt/wt, 1.75-2.5% wt/wt, 1.8-2.2% wt/wt, 1.9-2.1% wt/wt, or about 2% wt/wt.

In certain embodiments, the binder composition comprises sodium tripolyphosphate and chitosan in an aqueous solution comprising acetic acid.

The at least one active material can comprise a material capable of reversibly hosting lithium ions via both mechanisms, intercalation/deintercalation and/or alloying/dealloying. For example, active materials capable of hosting of lithium ions include, but are not limited to, natural graphite, artificial graphite, tin, antimony, and/or silicon-based material and their derivatives. If silicon is used as active material, it can be in crystalline or amorphous phase, or as a mixture of both. In addition to its phase, other types/forms of silicon that include nanowire, nanotube, flakes, plates, fiber, and SiOₓ (0<x<2) can be used. In certain embodiments, the average particle size of the silicon can range from 1 nm to 20 μm.

In certain embodiments, the at least one active material is silicon nanoparticles, monocrystalline silicon nanoparticles, monocrystalline silicon nanoflakes, silicon powder, silicon oxide, silicon oxide nanoparticles, SiOₓ particles, wherein 0<x<2, silicon nanotubes, silicon nanowires, tin nanopowder, tin oxide nanopowder, and combinations thereof.

The at least one conductive material improves the electrical conductivity of an electrode in a battery. Common conductive materials include, but are not limited to, carbon black, graphene, acetylene black, super P carbon black, graphite, hard carbon, carbon nanotubes and their combinations. In certain embodiments, the at least one conducting material can be a carbon conducting additive, a polymer conducting additive, a metal conducting additive, or a combination thereof. Suitable carbon conducting additive include, but are not limited to, natural graphite, artificial graphite, carbon fiber, carbon nanofibers, carbon black, acetylene black, Ketjen black, carbon nanotubes, graphene (e.g., 0D, 1D, 2D, and 3D), graphene oxide, and combinations thereof. In certain embodiments, the conducting additive is a carbon conducting agent selected from the group consisting of Super P, carbon black nanopowder, carbon nanoparticles, single-walled carbon nanotubes, double-walled carbon nanotubes, 3D graphene foam, graphene monolayer, graphene multilayer, graphene nanoplatelets, graphene oxide monolayer, graphene oxide paper, graphene oxide thin film, graphite nanofibers, graphite powder, graphite rods, and combinations thereof; a conducting polymer additive selected from the group consisting of polyacetylene, polypyrrole, poly(3,4-ethylenedioxythiophene):polystyrene sulfonate (PEDOT:PSS), polyaniline, polyparaphenylene vinylene, polyisothianaphthalene, polyparaphenylene sulphide, polyparaphenylene, and combinations thereof; or a conducting metal additive selected from the group consisting of copper, nickel, aluminium, silver, and the like.

In certain embodiments, at least one conducting material is selected from the group consisting of carbon black, Ketjen black, single-walled carbon nanotube (SWCNT), multi-walled carbon nanotube (MWCNT), carbon nanofibers (CNF), graphene oxide, conductive polymers, and combinations thereof.

An aqueous, coatable anode ink formulation for LIB application comprising a water-soluble polymeric binder along with active materials, conductive materials and modifiers has been developed. The anode ink formulation described herein features strong adhesive bonding of the electrode material to the current collector, superior cohesive-properties, and excellent electrochemical stability as a result of superior electronic and ionic conductivities. More specifically, the present disclosure relates to the preparation of an aqueous, coatable anode ink formulation for LIB, comprising at least one active material, at least one conductive material, and at least one binder composition.

The binder composition may be formed by any component that includes chitosan and derivatives thereof, dissolving in deionised (DI) water or in 0.1 to 10 v/v % acetic acid solution to obtain solutions in concentration range of 0.1 to 10 wt %. The thus formed chitosan solution can be cross-linked with at least one phosphate salt. The phosphate salt solution can be prepared in water. For example, 0.1-20 mg/mL tripolyphosphate (TPP) can be dissolved in aqueous solution. The phosphate salt solution can be added into the chitosan solution under mechanical or magnetic stirring. The phosphate salt to chitosan mass ratio may range from 1:1 to 1:100. The amount of the chitosan added may be range from about 1 to about 20 parts by weight based on 100 parts by weight of the negative electrode active material. The absence of binder materials may lead to the loss of the contact between active materials and current collector, resulting in capacity loss. Several properties of the chitosan can affect the binder performance, such as molecular weight, degree of substitution and degree of deacetylation. In certain embodiments, the molecular weight of the chitosan ranges from 1 kDa to 10,000 kDa and degree of deacetylation between 50 to 100%.

The binder composition may further comprise binder additives, such as LiPAA, PAA, carboxy methyl cellulose (CMC), alginate, tannic acid, citric acid, phytic acid, triton X-100, tin chloride, or a conductive polymer material, such as polypyrrole, polyacetylene, polyethylene oxide, polyethylene glycol, polyaniline, polythiophene, PEDOT:PSS, or polyphenylene derivatives can contribute to the formation of a network through ionic bridges between the polymeric chains. The binder composition can include materials capable of forming connectivity between the active material particles and while also improving lithium-ion transport from electrolyte to active materials, and additionally provide strong adhesion to the current collector. The binder composition with different chemical components present in them can contribute to both ion transport and mechanical binding capabilities.

In certain embodiments, the anode ink formulations comprises 10 to 90% by weight or 30 to 80% by weight of active materials; 0 to 40% by weight or 5 to 30% by weight of conductive materials; 0 to 30% by weight or 2 to 20% by weight of binders; and optionally 0.1 to 15% by weight or 0.1 to 10% by weight of additives; wherein the exact numbers in % by weight are based on the total weight of the anode ink formulation and the proportions of all constituents of the anode ink formulation add up to 100% by weight.

The present disclosure also provides a method of preparing the anode ink formulation. In certain embodiments, the method for preparing the anode ink formulation comprises: combining an aqueous solution comprising an acid, chitosan, and the least one phosphate salt or conjugate acid thereof thereby forming the binder composition; combining the binder composition, the at least one active material, the at least one conductive material, and thereby forming the anode ink formulation. The aqueous solution comprising an acid, chitosan, and the least one phosphate salt or conjugate acid, the binder composition, the at least one active material, and the at least on conductive material can be combined in accordance with the weight, weight/weight, weight/volume, and/or volume/volume stoichiometries described herein.

As demonstrated in Examples 5 and 6, improvements in the performance of negative electrodes prepared from the anode ink formulation described herein can advantageously be realized by the portion-wise addition of the at least one active material and/or the at least one conductive material to the binder composition.

In certain embodiments, the step of combining the at least one active material, the at least one conductive material, and the binder comprises combining the at least one active material and/or the at least one conductive material portion-wise and/or by slow addition with the binder composition. Portion-wise addition can comprise combining a material in two or more portions with the biner composition. In certain embodiments, portion-wise addition can comprise the combining the total amount of the at least one active material and/or the at least one conductive material in 2, 3, 4, 5, 6, 7, 8, 9, 10, or more portions with the binder composition. In certain embodiments, portion-wise addition can comprise combining the total amount of the at least one active material and/or the at least one conductive material in 2-10, 2-9, 2-8, 2-7, 2-6, 2-5, 2-4, 2-3, or 2 portions with the binder composition. The amount of the at least one active material and/or the at least one conductive material in each portion is not particularly limited. Accordingly, each portion can independently comprise substantially the same mass of the at least one active material and/or the at least one conductive material; or each portion the at least one active material and/or the at least one conductive material can independently differ in mass (for example, the mass of each portion added to the binder composition may increase, decrease, or not change).

Slow addition of the at least one active material and/or at least one conductive material to the binder composition can comprise addition of the materials over a period of 30 seconds to 72 hours to the binder composition. In certain embodiments, slow addition of the at least one active material and/or at least one conductive material can comprise addition of the material over a period of 30 seconds to 48 hours, 30 seconds to 24 hours, 30 seconds to 12 hours, 30 seconds to 10 hours, 30 seconds to 8 hours, 30 seconds to 6 hours, 30 seconds to 4 hours, 30 seconds to 4 hours, 30 seconds to 3 hours, 30 seconds to 2 hours, 30 seconds to 1 hours, 10 minutes to 3 hours, 30 minutes to 3 hours, 1 hour to 3 hours, or 1 hour to 2 hours to the binder composition.

The order of addition of the at least one active material and the at least one conductive material and the binder composition can also surprisingly improve performance of the negative electrode prepared from the anode ink formulation. The step of combining the at least one active material, the at least one conductive material, and the binder composition can comprise combining the binder composition with the at least one active material thereby forming a binder composition comprising the active material and combining the binder composition comprising the active material with the at least one conductive material thereby forming the anode ink formulation; or the step of combining the at least one active material, the at least one conductive material, and the binder composition can comprise combining the binder composition with the at least one conductive material thereby forming a binder composition comprising the conductive material and combining the binder composition comprising the conductive material with the at least one active material thereby forming the anode ink formulation. The results presented in Example 5, demonstrate that when the conductive material is added to the binder composition before the active material, that the resulting negative electrode has surprisingly improved performance.

In certain embodiments, the step of combining the at least one active material, the at least one conductive material, and the binder comprises combining the binder composition and the at least one conductive material thereby forming a binder composition comprising the conductive material; and combining the at least one active material and the binder composition comprising the conductive material thereby forming the anode ink formulation.

In certain embodiments, the step of combining the at least one active material, the at least one conductive material, and the binder comprises combining the binder composition and the at least one conductive material portion-wise thereby forming a binder composition comprising the conductive material; and combining the at least one active material portion-wise and the binder composition comprising the conductive material thereby forming the anode ink formulation.

In certain embodiments, the order of addition of the at least one active material and the at least one conductive material and portion-wise addition can both be modified for further improvements in the performance of negative electrodes prepared from the anode ink formulation.

The step of combining the at least one active material, the at least one conductive material, and the binder can comprise combining the binder composition and the at least one active material portion-wise thereby forming a binder composition comprising the active material; and combining the at least one active material portion-wise and the binder composition comprising the conductive material thereby forming the anode ink formulation. Various combinations of the order of addition and portion-wise addition of the at least one active material and/or at least one conductive material are also contemplated. Examples of such embodiments are described below.

Conductive Material Added First and Portion-wise Addition of Active Material. The step of combining the at least one active material, the at least one conductive material, and the binder can comprise combining the binder composition and the at least one conductive material thereby forming a binder composition comprising the conductive material; and combining the at least one active material portion-wise and the binder composition comprising the conductive material thereby forming the anode ink formulation.

Conductive Material Added First and Portion-wise Addition of Conductive Material. The step of combining the at least one active material, the at least one conductive material, and the binder comprises combining the binder composition and the at least one conductive material portion-wise thereby forming a binder composition comprising the conductive material; and combining the at least one active material and the binder composition comprising the conductive material thereby forming the anode ink formulation.

Conductive Material Added First and Portion-wise Addition of Active Material and Conductive Material. The step of combining the at least one active material, the at least one conductive material, and the binder can comprise combining the binder composition and the at least one conductive material portion-wise thereby forming a binder composition comprising the conductive material; and combining the at least one active material portion-wise and the binder composition comprising the conductive material thereby forming the anode ink formulation.

Active Material Added First and Portion-wise Addition of Conductive Material. The step of combining the at least one active material, the at least one conductive material, and the binder can comprise combining the binder composition and the at least one active material thereby forming a binder composition comprising the active material; and combining the at least one conductive material portion-wise and the binder composition comprising the conductive material thereby forming the anode ink formulation.

Active Material Added First and Portion-wise Addition of Active Material. The step of combining the at least one active material, the at least one conductive material, and the binder can comprise combining the binder composition and the at least one active material portion-wise thereby forming a binder composition comprising the active material; and combining the at least one conductive material and the binder composition comprising the active material thereby forming the anode ink formulation.

Active Material Added First and Portion-wise Addition of Active Material and Conductive Material. The step of combining the at least one active material, the at least one conductive material, and the binder can comprise combining the binder composition and the at least one active material portion-wise thereby forming a binder composition comprising the active material; and combining the at least one conductive material portion-wise and the binder composition comprising the active material thereby forming the anode ink formulation. The results presented in Example 6, demonstrate that when the active material is added in two portions to the binder composition before the addition of the active material in two portions, that the resulting negative electrode has surprisingly improved performance.

Premixing some or all of the at least one active material and at least one conductive material prior to combining with the binder composition can also surprisingly improve performance of the negative electrode prepared from the anode ink formulation. For example, in instances in which there are two active materials, the two active materials can be premixed prior to combining with the binder composition. Likewise, in instances in which there are two conductive materials, the two conductive materials can be premixed prior to combining with the binder composition. In certain embodiments, the at least one active material and at least one conductive material can be premixed thereby forming a premixture that can then be combined with the binder composition. The results presented in Example 6, demonstrate that when the active material and the conductive material are premixed prior to combining with the binder composition that the resulting negative electrode has surprisingly improved performance.

More complex addition sequences of the active material and conductive material are also contemplated by the present disclosure. For example, one portion of the at least one active material can be added to the binder composition, followed by two portions of the at least one conductive material, and then one portion of the at least one active material added. As shown by the results in Example 6, such addition sequences can also yield improvements in performance of the negative electrode prepared from the anode ink formulation described herein.

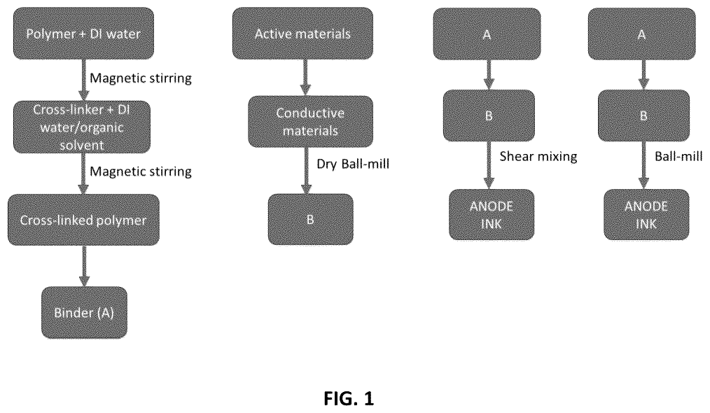

A schematic diagram depicting exemplary mixing sequences for preparing the anode ink formulation described herein are shown in FIG. 1.

The present disclosure also provides a method of preparing negative anode, the method comprising removing at least a portion of the water in the anode ink formulation described herein thereby forming the negative anode. In certain embodiments, all or substantially all of the water in the anode ink formulation is removed. Any method known in the art can be used to remove the water from the anode ink formulation. The selection of the appropriate method is well within the skill in the ordinary person of skill in the art. Exemplary methods include, but are not limited to, subjecting the anode ink formulation to at least one of reduced pressure (e.g., vacuum) and heat. In certain embodiments, the method of preparing the negative anode further comprises applying the anode ink formulation to a surface of current collector and removing at least a portion of the water from the anode ink formulation thereby forming a coated current collector.

An exemplary method for preparing anode ink formulation and applying the anode ink formulation to a substate comprises of the following steps:
Dissolving polymer in deionised water or in 0.1 to 10 v/v % acetic acid solution to obtain solutions in concentration range of 0.1 to 10 wt % (mechanical stirring);
Dissolve cross-linker in deionised water or organic solvent depending on the derivative selection with magnetic stirring;
Mixing a polymer solution with cross-linker solution to obtain cross-linked polymer, (binder solution) under magnetic stirring and maintaining acidic pH;
Mixing active material to obtain a pre-mixture, wherein the active material is selected from a group consisting of silicon and/or graphite;
Mixing conductive materials to obtain a pre-mixture, wherein the conductive material is selected from the group consisting of carbon black, super P, carbon nanofiber (CNF), carbon nanotube (CNT), and other conductive additives;
Combining the pre-mixed particles of active and conductive materials with cross-linked polymer to obtain a coatable anode ink (solid content ranging from 5 to 50 wt %) homogenously mixed with ball-mill and/or followed by shear mixing;
Viscous ink coating onto a copper foil different thickness using an automatic film coater via a doctor blade. However, the coating can also be performed by dip coating, screen printing, spray coating, or coating using a slot die, depending on the viscosity of the anode ink. The suitable viscosity range of the aqueous coatable anode ink is between 5 to 80 Pas;
Drying the electrode containing coated anode ink at different temperature followed by vacuum drying; and
Treating the coated anode ink surface so that the electrode is prepared for use in a lithium battery cell; wherein steps include rolling/calendaring the coated electrode, and vacuum drying prior to the coin cell preparation.

The present disclosure also provides a lithium battery comprising: a positive electrode; a negative electrode disposed opposite to the positive electrode; and an electrolyte disposed between the positive electrode and the negative electrode, wherein the negative electrode is prepared using the anode ink formulation described herein.

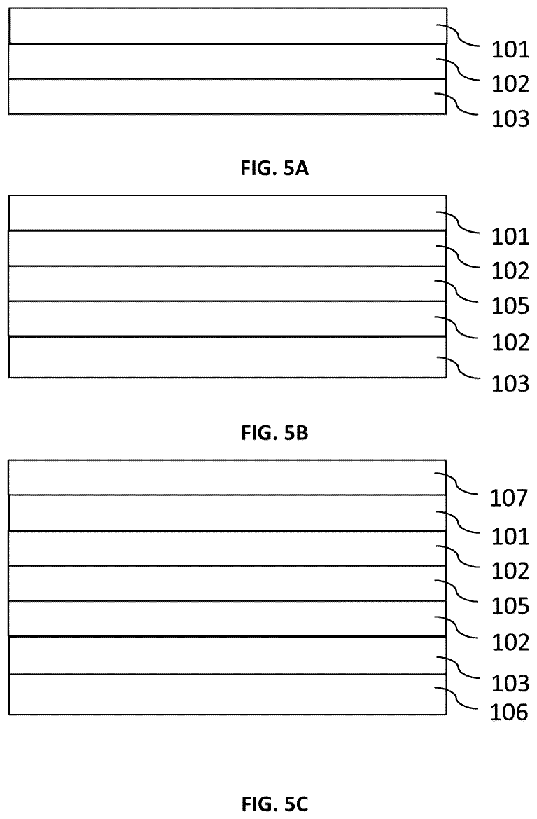

FIG. 5A depicts an exemplary battery configuration according to certain embodiments described herein, comprising a positive electrode 103; a negative electrode disposed opposite to the positive electrode 101; and an electrolyte disposed between the positive electrode and the negative electrode 102, wherein the negative electrode 101 is prepared using the anode ink formulation described herein.

The lithium-ion battery can be of any type known in the art. Exemplary batteries include, but are not limited to, coin cell, cylindrical cell (including 18650 cells), pouch cell, and prismatic cell.

Any electrolyte known in the art can be used in the lithium battery described herein. In certain embodiments, the electrolyte is a lithium salt-containing non-aqueous electrolyte. For example, the non-aqueous electrolyte may be a non-aqueous liquid electrolyte, an organic solid electrolyte, or an inorganic solid electrolyte.

The non-aqueous liquid electrolyte can comprise at least one electrolyte solvent selected from propylene carbonate, ethylene carbonate, butylene carbonate, dimethyl carbonate (DMC), diethyl carbonate, methyl ethyl carbonate (MEC), fluoroethylene carbonate (FEC), γ-butyrolactone, methyl formate, methyl acetate, 1,2-dimethoxyethane, tetrahydrofuran, 2-methyltetrahydrofuran, dimethyl sulfoxide, 1,3-dioxolane, formamide, dimethylformamide, dioxane, acetonitrile, nitromethane, ethyl monoglyme, phosphoric triesters, trimethoxymethane, dioxolane derivatives, sulfolane, 3-methyl-2-oxazolidinone, propylene carbonate derivatives, tetrahydrofuran derivatives, ethyl ether, 1,3-propanesultone, N-methyl acetamide, acetonitrile, acetals, ketals, sulfones, sulfolanes, aliphatic ethers, cyclic ethers, glymes, polyethers, phosphate esters, siloxanes, dioxolanes, and N-alkylpyrrolidones. In certain embodiments, the non-aqueous liquid electrolyte comprises EC, DMC, DEC, EMC, FEC, and combinations thereof.

Non-limiting examples of the organic solid electrolyte are polyethylene derivatives, polyethylene oxide derivatives, polypropylene oxide derivatives, phosphoric acid ester polymers, poly agitation lysine, polyester sulfide, polyvinyl alcohols, polyvinylidene fluoride, and polymers containing ionic dissociation groups.

Non-limiting examples of the inorganic solid electrolyte are nitrides, halides, sulfates, and silicates of lithium, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

The lithium salt may be any lithium salt that is in common use for lithium batteries, for example, any lithium salt that is soluble in the above-mentioned non-aqueous electrolytes. For example, the lithium salt may be at least one of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic carboxylic acid lithium, lithium tetraphenyl borate, LiNO₃, lithium bisoxalatoborate, lithium oxalyldifluoroborate, and lithium bis(trifluoromethanesulfonyl)imide.

Exemplary electrolytes include, but are not limited to, LiPF₆ in EC:DMC=1:1 Wt %; EC:DEC:EMC=1:1:1 Vol %; EC:DEC=1:1 Vol % with 5.0% FEC; EC:DMC:DEC=1:1:1 Vol %; EC:DMC:EMC=1:1:1 Wt %; EC:DEC=1:1 Vol %; EC:DMC=1:1 Vol % with 5.0% FEC; EC:DMC=1:1 Vol % with 10.0% FEC; EC:DEC=1:1 Wt %; EC:EMC-3:7 Vol %; EC:EMC=3:7 Vol % with 5.0% FEC; EC:EMC=3:7 Vol % with 10.0% FEC; EC:EMC=3:7 Wt %; EC:EMC=3:7 Wt % with 5.0% FEC; EC:EMC=3:7 Wt % with 10.0% FEC; EC:DMC:EMC=1:1:1 Vol %; and EC:DMC=1:1 Vol %.

In certain embodiments, provided herein is a lithium battery comprising: a positive electrode; a negative electrode disposed opposite to the positive electrode; a separator substrate disposed between the positive electrode and the negative electrode; and an electrolyte disposed between the separator substrate and the positive electrode and the separator substrate and the negative electrode; and wherein the negative electrode is prepared from the anode ink formulation described herein.

FIG. 5B depicts an exemplary battery configuration according to certain embodiments described herein, comprising a positive electrode 103; a negative electrode disposed opposite to the positive electrode 101; a separator substrate 105 disposed between the positive electrode 103 and the negative electrode 101; and an electrolyte 102 disposed between the separator substrate 105 and the positive electrode 103 and the separator substrate 105 and the negative electrode 101; and wherein the negative electrode is prepared from the anode ink formulation described herein.

In certain embodiments, the separator substrate 105 is selected from polyolefin, fluorine-containing polymers, cellulose polymers, polyimides, nylons, glass fibers, alumina fibers, porous metal foils, and combinations thereof.

The separator substrate 105 can be made from a polyolefin. Exemplary polyolefins include, but are not limited to, polyethylene (PE), ultra-high molecular weight polyethylene (UHMWPE), polypropylene (PP), polymethylpentene (PMP), polybutylene, copolymers of any of the foregoing, and mixtures thereof. In certain embodiments, the separator substrate 105 is a polyolefin, such as polyethylene, polypropylene, polybutylene, or combinations thereof (e.g., Celgard® separators, Celgard LLC, Charlotte, N.C., US). The separator substrate 105 can be made by either a dry stretch process (also known as the CELGARD® process) or a solvent process (also known as the gel extrusion or phase separation process).

In certain embodiments, provided herein is a lithium battery comprising: a positive electrode current collector; a positive electrode; a negative electrode current collector; a negative electrode disposed opposite to the positive electrode; a separator substrate disposed between the positive electrode and the negative electrode; and an electrolyte disposed between the separator substrate and the positive electrode and the separator substrate and the negative electrode; and wherein the negative electrode is prepared from the anode ink formulation described herein.

FIG. 5C depicts an exemplary battery configuration according to certain embodiments described herein, comprising a positive electrode current collector 106; a positive electrode 103; a negative electrode current collector 107; a negative electrode disposed opposite to the positive electrode 101; a separator substrate 105 disposed between the positive electrode 103 and the negative electrode 101; and an electrolyte 102 disposed between the separator substrate 105 and the positive electrode 103 and the separator substrate 105 and the negative electrode 101; and wherein at least one of the positive electrode 103 and the negative electrode 101 comprises a binder or binder composition described herein.

The negative electrode current collector 107 may be any material having a conductivity without causing a chemical change in the lithium battery, for example, copper, stainless steel, aluminium, nickel, titanium, sintered carbon, or copper or stainless steel of which a surface is treated with carbon, nickel, titanium, silver, or the like, or an aluminium-cadmium alloy. Additional exemplary negative electrode current collectors 107 include, but are not limited to copper foil, copper mesh foil, copper foam sheets, nickel foam sheets, nickel mesh foil, and nickel foil. In some embodiments, the negative electrode current collector 107 may be in any of various forms, including a film, a sheet, a foil, a net, a porous structure, foam, and non-woven fabric.

The negative electrode can be prepared by applying the anode ink formulation described herein to the surface of the negative electrode current collector and removing at least a portion of the water from the anode ink formulation thereby forming the negative electrode applied to the surface of the negative electrode. Water can be removed from the anode ink formulation by the application of at least one of heat, reduced pressure, or evaporation at room temperature.

The positive electrode current collector 106 may be any material having a high conductivity without causing a chemical change in the lithium battery, for example, stainless steel, aluminium, nickel, titanium, sintered carbon, or aluminium or stainless steel of which a surface is treated with carbon, nickel, titanium, silver, or the like. In some embodiments, the positive electrode current collector 106 may have fine irregularities on a surface thereof so as to have enhanced adhesive strength to the positive active material. The positive electrode current collector 106 may be in any of various forms, including a film, a sheet, a foil, a net, a porous structure, foam, and non-woven fabric.

In the examples below, coin-type half-cells were assembled with the electrode consisting of aqueous coated anode ink with a diameter of 14 mm that were punched out to be assembled in CR2032 coin cells in an argon filled glove-box. Lithium metal foil was used as a counter electrode, and Celgard 2325 (or H2512) as a separator. The electrolyte may be any suitable electrolyte used for lithium-ion batteries. For example, a lithium electrolyte salt dissolved in a single solvent or a solvent mixture containing two or more solvents mixed in different volume ratios, e.g., 1:1 or 3:7 or 1:1:1 and with different lithium salt concentration, e.g., 1M/1.2M/1.5M/2M etc. For example, the electrolyte solution may contain lithium hexaflourophosphate (LiPF₆) uniformly dissolved in a solvent mixture of ethylene carbonate (EC), dimethyl carbonate (DMC), ethyl methyl carbonate (EMC) and diethylene carbonate (DEC). i.e., 1.2 M LiPF₆ in ethylene carbonate/ethyl methyl carbonate (EC/EMC, 3:7 by weight) with 10% fluoroethylene carbonate (FEC) and/or 2% vinylene carbonate (VC) as the additive. For example, the electrolyte solution may contain lithium 4,5-dicyano-2-(trifluoromethyl)imidazole (LiTDI)/lithium bis(trifluoromethanesulfonyl)imide (LiTFSi) in EC/EMC/DMC/DEC with 1% (VC) and/or 5% or 10% FEC as additives.

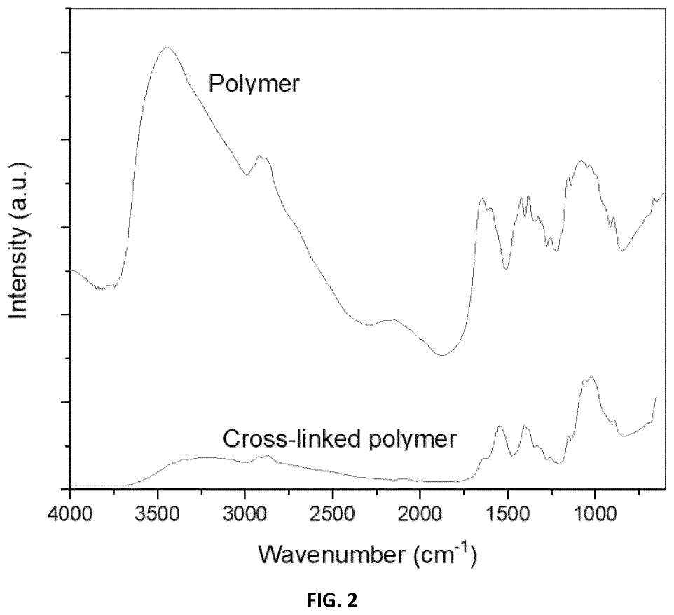

FTIR spectroscopy was employed to obtain information about the cross-linking reaction. FTIR spectra of polymer and cross-linked polymer are shown in FIG. 2. The main peaks corresponding to the key functional groups observed in both polymer and the cross-linked polymers such as —OH, —NH, —CH and —CN confirmed the cross-linking reaction in the polymer. The polar groups such as —COOH, —NH₂ and —OH present in the polymer provided enough adsorption sites for interaction with active materials in the present case of water-based anode ink (composed of cross-linked polymer with active materials and conductive materials).

The viscosity of the cross-linked polymer and coatable anode ink as a function of shear rates exhibits shear thinning thixotropic properties and non-Newtonian characteristics i.e., the viscosity decreases as the shear rate increases. The viscosity at low shear rates is a measure of the settling behaviour of solids and that at high shear rates is a measure of the processibility. The high viscosity at the low shear rates observed with the anode ink is preferred since the settling of solid ingredients is not significant. The low viscosity at the high shear rates observed with the anode ink is also a favourable feature because more uniform coating is expected with less viscous anode ink.

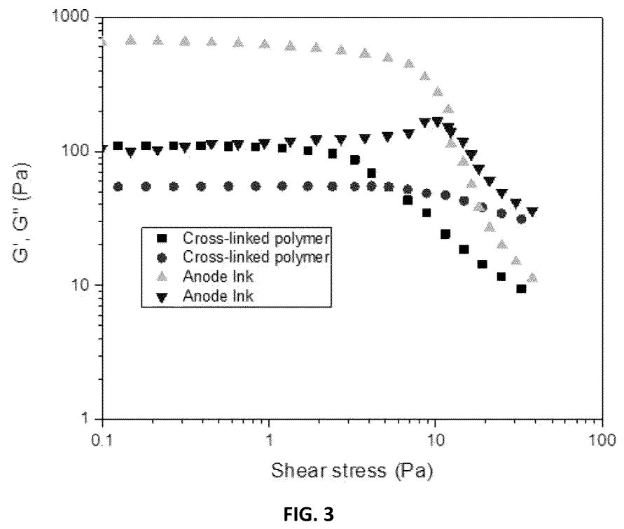

FIG. 3 shows the storage modulus (G′) and loss modulus (G″) of cross-linked polymer and anode ink, to the applied shear stress varying from 0.1-100 Pa. They exhibit similar dynamic behaviour despite different values of G′ and G″. The linear viscoelastic (LVE) region was observed at low shear stresses, and the values are found to be 1.2 and 2.7 Pa for cross-linked polymer and anode ink, respectively. The LVE region is defined as the region where the anode ink can endure the mechanical deformation without damaging its molecular structure. In LVE region, most of the input mechanical energy is stored in the deformed yet not destructed polymer chains as such the sample elastically recovers once retrieving the applied stress. The value of shear stress at G′=G″, indicates the sample cohesiveness and is found to be 5.3 and 12.3 Pa, for the cross-linked polymer and the anode ink, respectively. After the cross-over point, G″ became higher than G′, and the sample turns from solid-like to liquid-like. The anode ink exhibits the higher value of critical stress at cross-over point and suggests the need for a greater shear stress input to force the transition such that the mix presents tackiness and cohesiveness during processing.

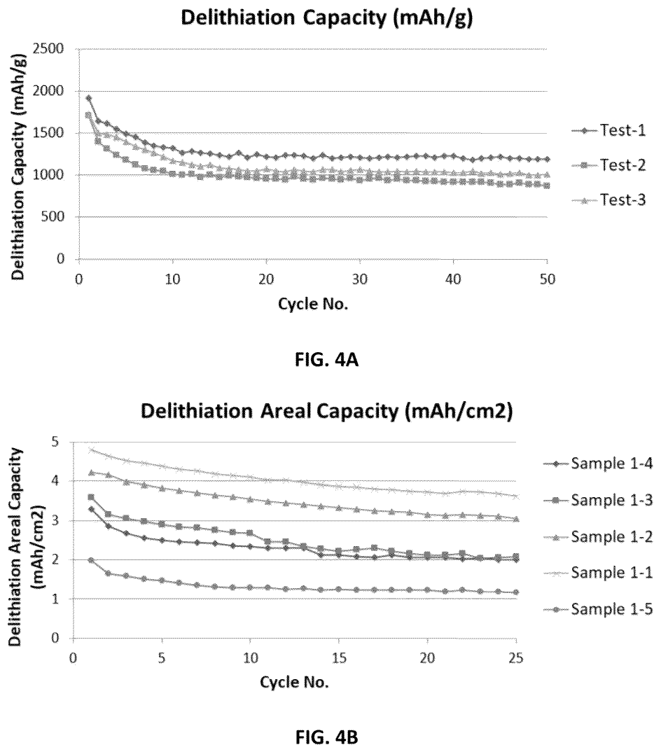

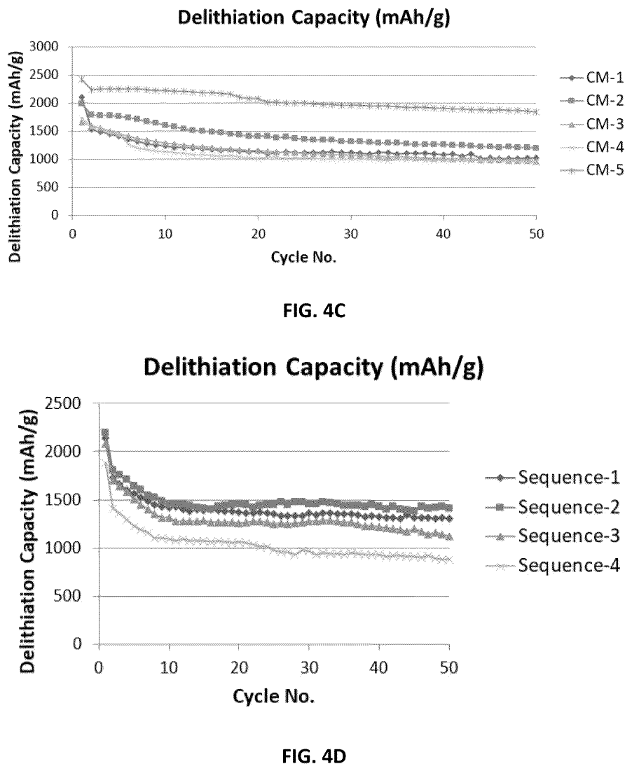

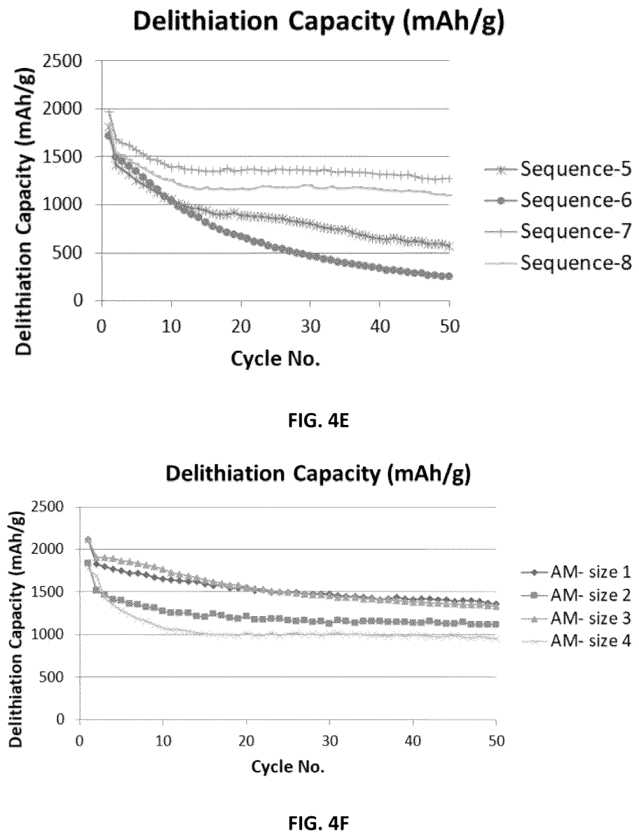

Cells are subjected to repeated charge-discharge cycles in the battery testing system machine, for its rate and cycle performance (FIG. 4). The rate performance of the anode was tested by setting different charge-discharge rates of 0.1C, 0.5C, 1C, and 10C along with cycling them for 20-200 cycles. This enables us to determine the suitability of the anode material for fast charge-discharge rates and its consideration for commercial applications. The batteries were cycled at 0.1C between 0.01-1 V. These anodes exhibit high capacities ranging from 500 to 2,500 mAh/g and areal capacities ranging from 1 to 5 mAh/cm², respectively. Moreover, they exhibit a very stable cycling performance for 50 cycles or more with 1C, as shown in FIGS. 4A-E as an example. This confirms that the present aqueous coatable anode ink is robust enough to support both mechanically and electrically during delithiation capacities when investigated for high current density (e.g., 1C). FIG. 4A depicts the repeatability of the electrochemical performance of the anode ink formulation (for example: with 65% AM 15% CM 20% Binder). Fine tuning of the aerial capacity through variation of mass loading in the electrodes is demonstrated in FIG. 4B. Synergistic effect of conductive materials and their variations (for example: carbon black (CB)/CNF/CNT etc) on the electrochemical performance of the anode ink formulation can be seen in FIG. 4C. The steps (iv) and (v) of the mixing sequence (given in the example method) in the formulation of the anode ink can be interchanged and the resultant electrode performances are represented in the FIGS. 4D and 4E. Active material particle size variations (1&2 Si D50 particle size distribution <100 nm and 3&4 Si D50 particle size distribution <200 nm) in the coatable anode ink resulted in electrode performances shown in FIG. 4F.

### EXAMPLES

### Example 1—Performance Variation of Anode Ink Formulation

Chitosan was dissolved in 1% v/v aqueous acetic acid solution while stirred mechanically to obtain 2% by weight chitosan solution. Tripolyphosphate as a crosslinker was dissolved in ionized water [Chit/TPP weight ratio 8.3] and added dropwise to the chitosan solution under magnetic stirring to obtain the binder composition (concentration of chitosan and TPP in the binder composition is about 2% wt/wt) while maintaining pH<5. Premixed active materials (Si+graphite; 65% wt/wt) were then mixed with binder solution (20% wt/wt) in centrifugal mixer for 10 mins, followed by addition of premixed conductive materials (carbon black 10% wt/wt and CNT 5% wt/wt) and additional mixing in centrifugal mixer for 5 mins. As such obtained viscous anode ink was then mixed for 1 h with overhead disperser blade and coated on the copper foil via a doctor blade coater. Coated electrodes are then dried at 80° C. in the air until surface dried, followed by vacuum drying for 30 mins at 110° C.

Coin-type half-cells (CR2032) were then prepared with obtained electrodes with a diameter of 14 mm that were punched out and assembled in an argon filled glovebox. Lithium metal foil was used as a counter electrode, Celgard 2325 as a separator and 1.2 M LiPF₆ in EC:EMC (3:7) with 10% FEC as electrolyte.

The cells were then subjected to repeated charge-discharge cycling in battery testing system machine. They were cycled between 0.01 and 1.00 V, with one formation cycle at 0.1C and consequent aging cycles at 1C. The results of three such tests on three coin-type half-cells prepared from three separate batches of the anode ink formulation are presented in FIG. 4A.

### Example 2—Effect of Different Mass Loadings on Anode Ink Formulation Performance

Chitosan was dissolved in 1% v/v aqueous acetic acid solution while stirred mechanically to obtain 2% by weight chitosan solution. Tripolyphosphate as a crosslinker was dissolved in ionized water [Chit/TPP weight ratio 8.3] and added dropwise to chitosan solution under magnetic stirring to obtain the binder composition (concentration of chitosan and TPP in the binder composition is about 2% wt/wt) while maintaining pH<5. Premixed active materials (Si+graphite; 65% wt/wt) were then mixed with binder solution (20% wt/wt) in centrifugal mixer for 10 mins, followed by addition of premixed conductive materials (carbon black 10% wt/wt and CNT 5% wt/wt) and additional mixing in centrifugal mixer for 5 mins. As such obtained viscous anode ink was then mixed for 1 h with overhead disperser blade and coated on the copper foil via a doctor blade coater. Different mass loadings of the anode ink (FIG. 4B, 1-1 (2.80 mg/cm²); 1-2 (2.62 mg/cm²); 1-3 (2.35 mg/cm²); 1-4 (2.04 mg/cm²); 1-5 (1.07 mg/cm²)) were applied to the copper foil. Coated electrodes are then dried at 80° C. in the air until surface dried, followed by vacuum drying for 30 mins at 110° C.

Coin-type half-cells (CR2032) were then prepared with obtained electrodes with a diameter of 14 mm that were punched out and assembled in an argon filled glovebox. Lithium metal foil was used as a counter electrode, Celgard 2325 as a separator and 1.2 M LiPF₆ in EC:EMC (3:7) with 10% FEC as electrolyte.

The cells were then subjected to repeated charge-discharge cycling in battery testing system machine. They were cycled between 0.01 and 1.00 V, with one formation cycle at 0.1C and consequent aging cycles at 1C. Testing results of different mass loadings of the anode ink formulation (1-1 (2.80 mg/cm²); 1-2 (2.62 mg/cm²); 1-3 (2.35 mg/cm²); 1-4 (2.04 mg/cm²); 1-5 (1.07 mg/cm²)) are presented in FIG. 4B.

### Example 4—Effect of Different Conductive Materials on Anode Ink Formulation Performance

Chitosan was dissolved in 1% v/v aqueous acetic acid solution while stirred mechanically to obtain 2% by weight chitosan solution. Tripolyphosphate as a crosslinker was dissolved in ionized water [Chit/TPP weight ratio 8.3] and added dropwise to chitosan solution under magnetic stirring to obtain the binder composition (concentration of chitosan and TPP in the binder composition is about 2% wt/wt) while maintaining pH<5. Premixed active materials (Si+graphite; 65% wt/wt) were then mixed with binder solution (20% wt/wt) in centrifugal mixer for 10 mins, followed by addition of premixed conductive materials [CM-1 (10% wt/wt carbon super P-Li+5% wt/wt CNF); CM-2 (10% wt/wt carbon black C65+5% wt/wt CNF); CM-3 (10% wt/wt carbon black C65+5% wt/wt CNF); CM-4 (10% wt/wt carbon black C65+5% wt/wt Sn); CM-5 (10% wt/wt carbon black C65+5% wt/wt Sn+5% wt/wt CNT)] and additional mixing in centrifugal mixer for 5 mins. As such obtained viscous anode ink was then mixed for 1 h with overhead disperser blade and coated on the copper foil via a doctor blade coater. Coated electrodes are then dried at 80° C. in the air until surface dried, followed by vacuum drying for 30 mins at 110° C.

Coin-type half-cells (CR2032) were then prepared with obtained electrodes with a diameter of 14 mm that were punched out and assembled in an argon filled glovebox. Lithium metal foil was used as a counter electrode, Celgard 2325 as a separator and 1.2 M LiPF₆ in EC:EMC (3:7) with 10% FEC as electrolyte.

The cells were then subjected to repeated charge-discharge cycling in battery testing system machine. They were cycled between 0.01 and 1.00 V, with one formation cycle at 0.1C and consequent aging cycles at 1C. The testing results coin-type half-cells with prepared using different conductive materials [CM-1 (10% wt/wt carbon super P-Li+5% wt/wt CNF); CM-2 (10% wt/wt carbon black C65+5% wt/wt CNF); CM-3 (10% wt/wt carbon black C65+5% wt/wt CNF); CM-4 (10% wt/wt carbon black C65+5% wt/wt Sn); CM-5 (10% wt/wt carbon black C65+5% wt/wt Sn+5% wt/wt CNT)] are presented in FIG. 4C.

### Example 5—Effect of Order of Addition/Sequence of Conductive Material and Active Material on Anode Ink Formulation Performance

Chitosan was dissolved in 1% v/v acetic acid aqueous solution while stirred mechanically. Tripolyphosphate as a crosslinker was dissolved in ionised water [Chit/TPP mass ratio 8.3] and added dropwise to polymer solution under magnetic stirring to obtain the binder composition (concentration of chitosan and TPP in the binder composition is about 2% wt/wt) while maintaining pH<5. Active material (Si; 60% wt/wt) and conductive material (carbon black; 20% wt/wt) were mixed in different order of addition/sequences with the binder solution (20% wt/wt) material (Sequence 1—addition of Si followed by carbon black; Sequence 2—carbon black followed by Si; Sequence 3—Si followed by carbon black; Sequence 4—premixed Si (30% wt/wt) and carbon black (20%), followed by Si (30% wt/wt)) with mixing in a centrifugal mixer for 10 mins. As such obtained viscous anode ink was then mixed for 1 h with overhead disperser blade and coated on the copper foil via a doctor blade coater. Coated electrodes are then dried at 80° C. in the air until surface dried, followed by vacuum drying for 30 mins at 110° C.

Coin-type half-cells (CR2032) were then prepared with obtained electrodes with a diameter of 14 mm that were punched out and assembled in an argon filled glovebox. Lithium metal foil was used as a counter electrode, Celgard 2325 as a separator and 1.2 M LiPF₆ in EC:EMC (3:7) with 10% FEC as electrolyte.

The cells were then subjected to repeated charge-discharge cycling in battery testing system machine. They were cycled between 0.01 and 1.00 V, with one formation cycle at 0.1C and consequent aging cycles at 1C. The results of coin-type half-cells prepared from anode ink formulations prepared using different orders of addition/sequence of the active material and conductive material (Sequence 1—addition of Si followed by carbon black; Sequence 2—carbon black followed by Si; Sequence 3—Si followed by carbon black; Sequence 4—premixed Si (30% wt/wt) and carbon black (20%), followed by Si (30% wt/wt)) are shown in FIG. 4D.

### Example 6—Effect of Order of Addition/Sequence of Conductive Material and Active Material on Anode Ink Formulation Performance

Chitosan was dissolved in 1% v/v aqueous acetic acid solution while stirred mechanically to obtain 2% by weight chitosan solution. Tripolyphosphate as a crosslinker was dissolved in ionized water [Chit/TPP weight ratio 8.3] and added dropwise to chitosan solution under magnetic stirring to obtain the binder composition (solids content of binder composition is about 2% wt/wt) while maintaining pH<5. The premixed active materials (Si+graphite; 65% wt/wt) and conductive materials (carbon black 10% wt/wt and CNT 5% wt/wt) were mixed in different order of addition/sequences with the binder composition (20% wt/wt) (Sequence 5—addition of premixed Si, graphite, and carbon black followed by addition of CNT; Sequence 6—addition of premixed Si and graphite followed by addition of premixed carbon black and CNT; Sequence 7—addition of premixed Si, graphite, carbon black, and CNT; Sequence 8—addition of Si followed by addition of premixed carbon black and CNT, followed by addition of graphite and additional mixing in centrifugal mixer for 5 mins). As such obtained viscous anode ink was then mixed for 1 h with overhead disperser blade and coated on the copper foil via a doctor blade coater. Coated electrodes are then dried at 80° C. in the air until surface dried, followed by vacuum drying for 30 mins at 110° C.

Coin-type half-cells (CR2032) were then prepared with obtained electrodes with a diameter of 14 mm that were punched out and assembled in an argon filled glovebox. Lithium metal foil was used as a counter electrode, Celgard 2325 as a separator and 1.2 M LiPF₆ in EC:EMC (3:7) with 10% FEC as electrolyte.

The cells were then subjected to repeated charge-discharge cycling in battery testing system machine. They were cycled between 0.01 and 1.00 V, with one formation cycle at 0.1C and consequent aging cycles at 1C. The results of coin-type half-cells prepared from anode ink formulations prepared using different orders of addition/sequence of the active material and conductive (carbon black 10% wt/wt and CNT 5% wt/wt) in different order of addition/sequences (Sequence 5—addition of premixed Si, graphite, and carbon black followed by addition of CNT; Sequence 6—addition of premixed Si and graphite followed by addition of premixed carbon black and CNT; Sequence 7—addition of premixed Si, graphite, carbon black, and CNT; Sequence 8—addition of Si followed by addition of premixed carbon black and CNT, followed by addition of graphite and additional mixing in centrifugal mixer for 5 mins) are shown in FIG. 4E.

### Example 7—Effect of Active Materials Average Particle Size on Anode Ink Formulation Performance

Chitosan was dissolved in 1% v/v aqueous acetic acid solution while stirred mechanically to obtain 2% by weight chitosan solution. Tripolyphosphate as a crosslinker was dissolved in ionized water [Chit/TPP weight ratio 8.3] and added dropwise to chitosan solution under magnetic stirring to obtain the binder composition (concentration of chitosan and TPP in the binder composition is about 2% wt/wt) while maintaining pH<5. Premixed active materials (Si+graphite; 65% wt/wt) of different average particle size (1&2 Si D50 particle size distribution=100 nm; 3&4 Si D50 particle size distribution=D90 of 200 nm) were then mixed with binder solution (20% wt/wt) in centrifugal mixer for 10 mins, followed by addition of premixed conductive materials (carbon black 10% wt/wt and CNT 5% wt/wt) and additional mixing in centrifugal mixer for 5 mins. As such obtained viscous anode ink was then mixed for 1 h with overhead disperser blade and coated on the copper foil via a doctor blade coater. Coated electrodes are then dried at 80° C. in the air until surface dried, followed by vacuum drying for 30 mins at 110° C.

Coin-type half-cells (CR2032) were then prepared with obtained electrodes with a diameter of 14 mm that were punched out and assembled in an argon filled glovebox. Lithium metal foil was used as a counter electrode, Celgard 2325 as a separator and 1.2 M LiPF₆ in EC:EMC (3:7) with 10% FEC as electrolyte.

The cells were then subjected to repeated charge-discharge cycling in battery testing system machine. They were cycled between 0.01 and 1.00 V, with one formation cycle at 0.1C and consequent aging cycles at 1C. The results of coin-type half-cells prepared from anode ink formulations prepared using active materials (Si+graphite; 65% wt/wt) having different average particle size (1&2 Si D50 particle size distribution=100 nm; 3&4 Si D50 particle size distribution=200 nm) are shown in FIG. 4F.

What is claimed is:

1. An anode ink formulation comprising a binder composition, at least one active material, and at least one conductive material, wherein the binder composition comprises chitosan, at least one phosphate salt or conjugate acid thereof, and water, wherein the at least one phosphate salt is selected from the group consisting of orthophosphate metal salts, pyrophosphate metal salts, and polyphosphate metal salts; the binder composition, the at least one active material, and the at least one conductive material are present at a concentration of 10% to 30% wt/wt; 50 to 80% wt/wt; and 10 to 20% wt/wt, respectively; and the binder composition comprises the chitosan and the at least one phosphate salt or conjugate acid thereof at a concentration between 1.5-5% wt/wt.

2. The anode ink formulation of claim 1, wherein the at least one active material is selected from the group consisting of silicon, SiOₓ, graphite, tin, antimony, gallium, hard carbon, and combinations thereof, wherein x is 0<x<2.

3. The anode ink formulation of claim 1, wherein the at least one active material is silicon and graphite or graphite.

4. The anode ink formulation of claim 1, wherein the at least one conductive material is selected from the group consisting of carbon black, Ketjen black, single-walled carbon nanotube (SWCNT), multi-walled carbon nanotube (MWCNT), carbon nanofibers (CNF), graphene, hard carbon, graphene oxide, conductive polymers, and combinations thereof.

5. The anode ink formulation of claim 1, wherein the at least one conductive material is carbon black, CNF, or a mixture thereof.

6. The anode ink formulation of claim 1, wherein the binder composition comprises the chitosan and the at least one phosphate salt or conjugate acid thereof at a concentration of 1.5-2.5% wt/wt.

7. The anode ink formulation of claim 1, wherein the binder composition further comprises an organic or inorganic acid at a concentration of 0.5% to 3% v/v.

8. The anode ink formulation of claim 1, wherein the binder composition comprises chitosan and sodium tripolyphosphate in a mass ratio 5:1 to 20:1 mass ratio.

9. The anode ink formulation of claim 1, wherein the at least one active material has a D50 particle size distribution between 50-300 nm.

10. The anode ink formulation of claim 1, wherein the binder composition, the at least one active material, and the at least one conductive material are present at a concentration of 15% to 25% wt/wt; 60 to 70% wt/wt; and 12 to 17% wt/wt, respectively.

11. The anode ink formulation of claim 1, wherein the method for preparing the anode ink formulation comprises at least one addition method selected from the group consisting of combining the active material portion-wise with the binder composition; combining the conductive material portion-wise with the binder composition; combining the conductive material with the binder composition before the active material is combined with the binder composition; and premixing the at least one active material and the at least one conductive material thereby forming a premixture and combining the premixture with the binder composition.

12. The anode ink formulation of claim 11, wherein the method for preparing the anode ink formulation comprises combining the conductive material with the binder composition before the active material is combined with the binder composition; or premixing the at least one active material and the at least one conductive material thereby forming a premixture and combining the premixture with the binder composition.

13. The anode ink formulation of claim 1, wherein the anode ink formulation comprises:
a binder composition, at least one active material, and at least one conductive agent,
wherein the binder composition comprises chitosan, at least one phosphate salt or conjugate acid thereof, and water, wherein the at least one phosphate salt is selected from the group consisting of orthophosphate metal salts, pyrophosphate metal salts, and polyphosphate metal salts;
the at least one active material is selected from the group consisting of silicon, SiOₓ, graphite, tin, antimony, gallium, and combinations thereof, wherein x is 0<x<2;
the at least one conductive material is selected from the group consisting of carbon black, Ketjen black, single-walled carbon nanotube (SWCNT), multi-walled carbon nanotube (MWCNT), carbon nanofibers (CNF), graphene oxide, conductive polymers, and combinations thereof;
the binder composition, the at least one active material, and the at least one conductive material are present in at a concentration of 10% to 30% wt/wt; 50 to 80% wt/wt; and 10 to 20% wt/wt, respectively; and
the binder composition comprises the chitosan and the at least one phosphate salt or conjugate acid thereof at a concentration between 1.5-2.5% wt/wt.

14. The anode ink formulation of claim 1, wherein the anode ink formulation comprises:
a binder composition, at least one active material, and at least one conductive agent,
wherein the binder composition comprises chitosan, at least one phosphate salt or conjugate acid thereof, and water, wherein the at least one phosphate salt is selected from the group consisting of orthophosphate metal salts, pyrophosphate metal salts, and polyphosphate metal salts;
the at least one active material is silicon and graphite or graphite;
the at least one conductive material is carbon black, CNF, or a mixture thereof;
the binder composition, the at least one active material, and the at least one conductive material are present in at a concentration of 15% to 25% wt/wt; 60 to 70% wt/wt; and 12 to 17% wt/wt, respectively; and
the binder composition comprises the chitosan and the at least one phosphate salt or conjugate acid thereof at a concentration between 1.75-2.25% wt/wt.

15. The anode ink formulation of claim 14, wherein the least one active material has a D50 particle size distribution between 50-200 nm.

16. The anode ink formulation of claim 14, wherein the method for preparing the anode ink formulation comprises adding the conductive material before the active material; or adding the active material in at least two portions before adding the conductive material in at least two portions.

17. A method of preparing the anode ink formulation of claim 1, the method comprising:
combining an aqueous solution comprising an acid, chitosan, and the least one phosphate salt or conjugate acid thereof thereby forming the binder composition; and
combining the binder composition, the at least one active material, the at least one conductive material, and thereby forming the anode ink formulation.

18. The method of claim 17, wherein the step of combining the at least one active material, the at least one conductive material, and the binder comprises:
combining the binder composition and the at least one conductive material thereby forming a binder composition comprising the conductive material; and
combining the at least one active material and the binder composition comprising the conductive material thereby forming the anode ink formulation; or
combining the at least one active material and the at least one conductive material thereby forming a premixture; and combining the premixture with the binder composition thereby forming the anode ink formulation.

19. A method of preparing a negative anode, the method comprising removing at least a some of the water from the anode ink formulation of claim 1.

20. The method of claim 19 further comprising the step of applying the anode ink formulation to the surface of a current collector and removing at least a portion of the water from the anode ink formulation thereby forming a coated current collector.

21. The negative anode prepared according to claim 19.

22. A battery comprising a positive electrode; the negative electrode of claim 21 disposed opposite to the positive electrode; and an electrolyte disposed between the positive electrode and the negative electrode.
